(19) United States
(12) Patent Application Publication
(10) Pub. No.: US 2015/0263573 A1
(43) Pub. Date: Sep. 17, 2015

(54) HIGH EFFICIENCY INTERNAL PERMANENT MAGNET SYNCHRONOUS ELECTRIC MACHINE

(71) Applicants: Anand Sathyan, Auburn Hills, MI (US); Hossein Dadkhah, Novi, MI (US)

(72) Inventors: Anand Sathyan, Auburn Hills, MI (US); Hossein Dadkhah, Novi, MI (US)

(21) Appl. No.: 14/215,936

(22) Filed: Mar. 17, 2014

(51) Int. Cl. H02K 1/27

(52) U.S. Cl. CPC H02K 1/276

(57) ABSTRACT

An internal permanent magnet synchronous electric machine has a rotor having a body of ferromagnetic material with a plurality of permanent magnets disposed wholly within the body and arranged in the body of the rotor as alternate North and South poles, each North and South pole formed by a pair of the permanent magnets arranged in a V with each magnet being a leg of the V with an apex of the V radially inwardly of ends of legs of the V so that each V opens outwardly in the body of the rotor at an obtuse electrical angle between the legs of the V of 135 degrees±one degree. The rotor has an outside diameter (Rotor OD) defined in terms of an outside diameter of a stator of the electric machine (Stator OD) as Rotor OD=Stator OD/(1.7±0.5%). Each North and South pole of the rotor has a pole-pitch to pole-arc ratio optimized for minimum cogging torque, maximum torque and optimized core loss.

### FIELD

The present invention relates to permanent magnet synchronous electric machines, and more a particularly, to a high efficiency internal permanent magnet synchronous electric machine.

### BACKGROUND

Permanent magnet synchronous electric machines are commonly used as the traction motor in electric vehicles including hybrid electric vehicles and battery electric vehicles. Of the various types of permanent magnet synchronous electric machines, the interior permanent magnet synchronous electric machine (IPM electric machine) is most often used for the traction motor due to their high power density and wide speed change. IPM electric machines are also commonly used for the traction motor/generator in hybrid electric vehicles that have traction motor/generators.

FIG. 1 is a simplified cross-section view of a typical prior art IPM motor 100 (which is an IPM electric machine). IPM motor 100 has two main parts—rotor 102 and stator 104. Stator 104 includes a body 106 of ferromagnetic material and conductive windings 108 (typically referred to as coils or coil windings and usually windings of copper wire) disposed in slots 110 in body 106. Body 106 is typically made of a stack or iron or steel laminations bonded together, but can be made in any known manner of making stators for IPM motors. Rotor 102 includes a body 112 made of ferromagnetic material and a plurality of permanent magnets 114 disposed in body 112. Permanent magnets 114 are arranged in body 112 of rotor 102 as alternate North and South poles and are disposed wholly within body 112. Body 112 is also typically a stack of iron or steel laminations bonded together, but can made in any known manner for making rotors for IPM motors. Rotor 102 is typically disposed within a central bore 116 of stator 104 and is mechanically free to rotate therein. Rotor 102 typically includes a central shaft 118 extending through a center of body 112 and is typically entrained within bearings (not shown).

With reference to IPM motor 200 in FIG. 2, in IPM motors that are traction motors for electric vehicles, a common configuration of the magnets is to have two generally flat magnets 202 for each North and South pole arranged in a V with each magnet 202 being one of the legs of the V. An apex 204 of the V is radially inwardly of the ends 206 of the legs (magnets 202) of the V so that the V opens outwardly in body 112 of rotor 102 at an obtuse angle θ between the legs (magnets 202) of the V.

Magnets 202 are for example rare earth magnets. One example of rare earth magnets used in IPM motors are neodymium iron boron magnets.

IPM traction motor/generators have the same basic structure as IPM motors, such as described above for IPM motors 100, 200.

It is an objective of the present invention to provide an IPM electric machine having a geometry which provides high efficiency at higher RPMs due to a higher reluctance torque component thus reducing the amount of magnet mass required.

### SUMMARY

An internal permanent magnet synchronous electric machine has a rotor having a body of ferromagnetic material with a plurality of permanent magnets disposed wholly within the body and arranged in the body of the rotor as alternate North and South poles. Each North and South pole is by a pair of the permanent magnets arranged in a V with each magnet being a leg of the V. An apex of V is radially inwardly of ends of legs of the V so that each V opens outwardly in the body of the rotor at an obtuse electrical angle between the legs of the V of 135 degrees±one degree. The electric machine also has a stator having a body of ferromagnetic material with a plurality of slots therein with conductive windings disposed in the slots. The rotor has an outside diameter (Rotor OD) defined in terms of an outside diameter of the stator (Stator OD) as Rotor OD=Stator OD/(1.7±6) where δ is 0.5%. Each North and South pole of the rotor has a pole-pitch to pole-arc ratio defined by:

$${α}_{p} = 1 - [ \frac{\frac{{N}_{c}}{P} - k}{\frac{{N}_{c}}{P}} ] [ \frac{n}{{( \frac{{N}_{c}}{P} )}^{2}} ] CPSR$$

where:
Nc=Least Common Multiple (Number of Stator Slots, Number of Poles)
P=Number of Poles
K=1, 2, 3, . . . .

$$Constant Power Speed Ratio CPSR = \frac{Maximum Speed}{Base Speed}$$

n=1 for CPSR=5 and n=0 for CPSR=2.
For CPSR values between 2 and 5, the n values are linearly interpolated between 1 and 0
n=0 for CPSR≦2 and n=1 for CPSR≧5.

In an aspect, the electric machine is an electric motor and the stator has an OD of 235 mm, a stack length of 93 mm, the rotor has an OD of 140 mm and the motor has a peak torque of at least 235 Nm at 400 Arms, a peak power of at least 65 Kw at 200 Vdc, and an efficiency of greater than ninety-six percent around 8000 RPM. In this aspect, the magnets are neodymium iron boron magnets and a total mass of the magnets is no more than 0.85 kg and in an aspect, is approximately 0/6 kg.

In an aspect, the electric machine is a traction motor/generator and the stator has an OD of 210 mm, a stack length of 60 mm, the rotor has an OD of 120 mm and the motor has a peak torque of at least 90 Nm, a peak power of at least 40 Kw, and an efficiency of greater than ninety-six percent around 6000 RPM. In this aspect, the magnets are neodymium iron boron magnets and a total mass of the magnets is no more than 0.6 kg and in an aspect, approximately 0.5 kg.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified cross-section view of a prior art IPM motor;

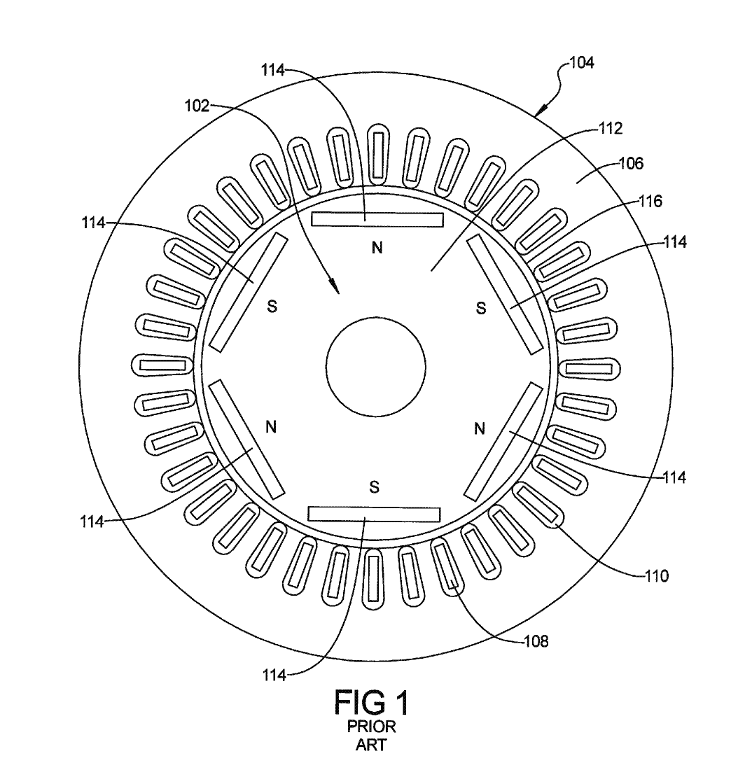

FIG. 2 is a simplified cross-section view of another prior art IPM motor;

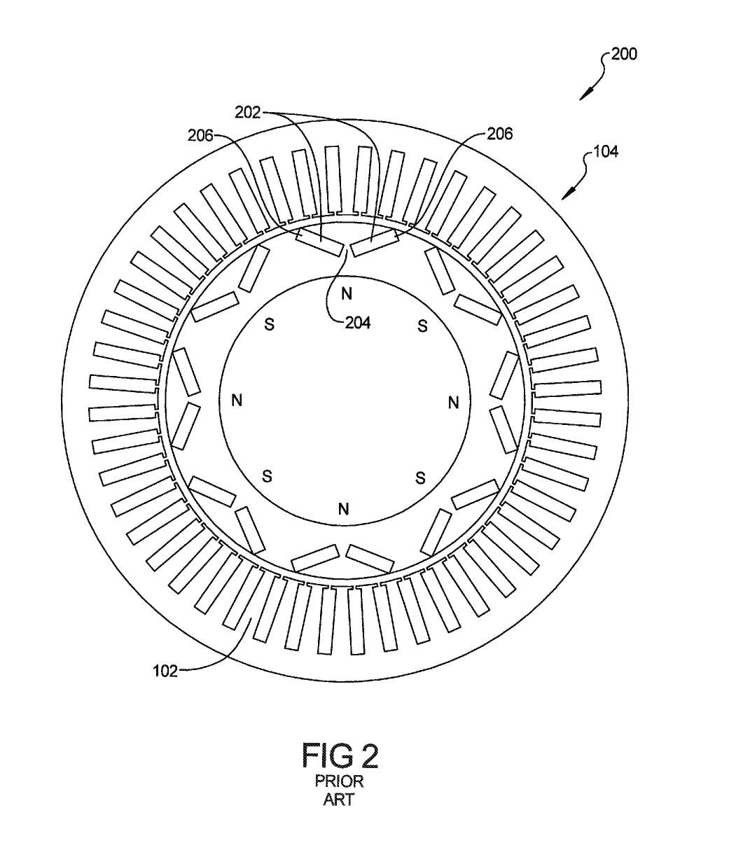

FIG. 3 is a simplified cross-section view of an IPM electric machine in accordance with an aspect of the present disclosure;

FIG. 4 is a perspective view of the IPM electric machine of FIG. 3; and

FIG. 5 is a simplified schematic view of a section of a rotor of the IPM electric machine of FIG. 3.

### DETAILED DESCRIPTION

The following description of the preferred embodiment(s) is merely exemplary in nature and is in no way intended to limit the invention, its application, or uses.

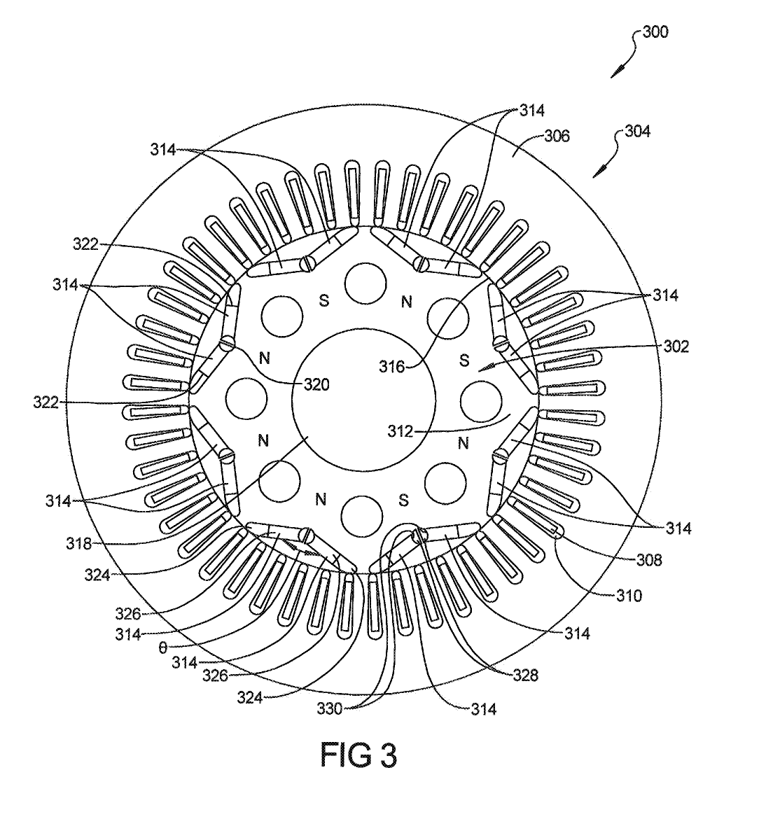

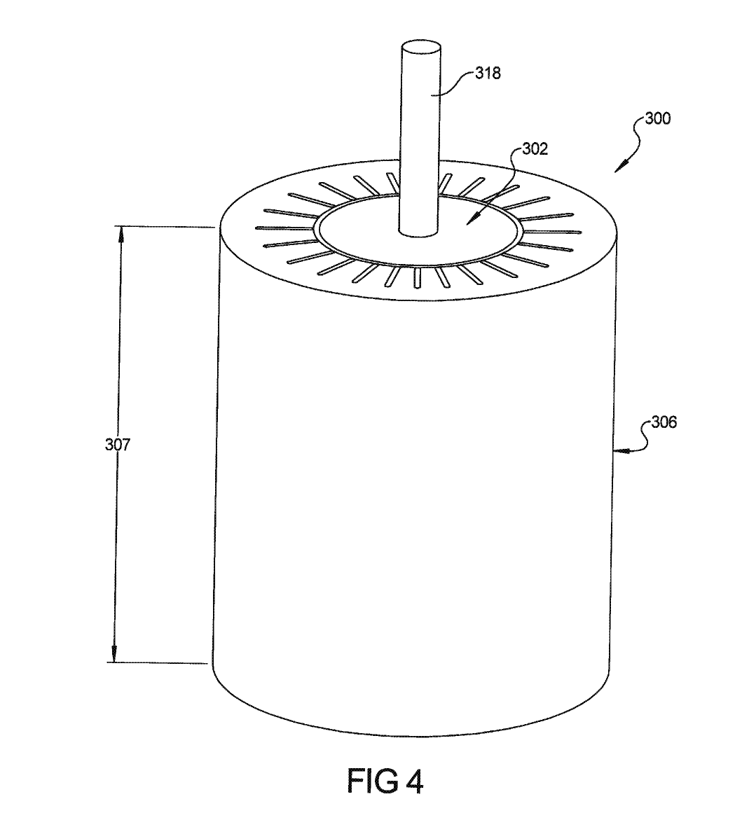

With reference to FIG. 3, a simplified cross-section view of an IPM electric machine 300 in accordance with an aspect of the present disclosure is shown. IPM electric machine 300 has a rotor 302 and a stator 304. Stator 304 has a body 306 of ferromagnetic material, commonly referred to in the art as stator back iron, and conductive windings 308 (such as windings of copper wire) disposed in slots 310 in body 306. Body 306 is illustratively made of a stack or iron or steel laminations bonded together having a length 307 (FIG. 4), but it should be understood that body 306 can be made in any known manner of making stators for IPM electric machines. Rotor 302 includes a body 312 made of ferromagnetic material and a plurality of permanent magnets 314 disposed in body 312. Permanent magnets 314 are arranged in body 312 of rotor 302 as alternate North and South poles and are disposed wholly within body 312. Body 312 is illustratively made of a stack of iron or steel laminations bonded together, but can made in any known manner for making rotors for IPM electric machines. Rotor 302 is disposed within a central bore 316 of stator 304 and is mechanically free to rotate therein. Rotor 302 has a central shaft 318 extending through a center of body 312 and is entrained in one or more bearings (not shown).

Each North and South pole is formed by a pair of magnets 314 arranged in a V within body 312 of rotor 302 with each magnet 314 being a leg of the V. An apex 320 of the V is radially inwardly of ends 322 of the legs (magnets 314) of the V so that the V opens outwardly in body 312 of rotor 302 at an obtuse electrical angle θ between the legs (magnets 202) of the V. In accordance with an aspect of the present disclosure, electrical angle θ is 135 degrees±one degree. In accordance with an aspect of the present disclosure, rotor 302 includes flux barriers 324 adjacent radially outer ends 326 of magnets 314 and flux barriers 328 adjacent radially inner ends 330 of magnets 314. In an aspect, flux barriers 324, 328 are air pockets in body 312 of rotor 302 adjacent ends 326, 330 of magnets 314. Flux barriers 324 adjacent radially outer ends 326 of magnets 314 in particular aid in maintaining the optimum pole-pitch to pole-arc ratio. Pole pitch is the period or distance between magnet poles. In other words, the distance from the center of one magnet pole to the center of the next magnet pole having an opposite magnetization direction. Pole pitch is thus 360 degrees divided by number of magnet poles of the rotor. It is usually expressed in terms of an angle or as a distance. Pole arc is the length of the pole face of an electric machine measured circumferentially around the rotor surface. The pole arc to pole pitch ratio decides the torque characteristics, torque ripple, back EMF waveform, saliency, demagnetization, stress and efficiency]

Rotor 302 has an outside diameter (OD) that is defined in terms of an outside diameter of stator 304 as follows:

Rotor OD=Stator OD/(1.7±0.5%)

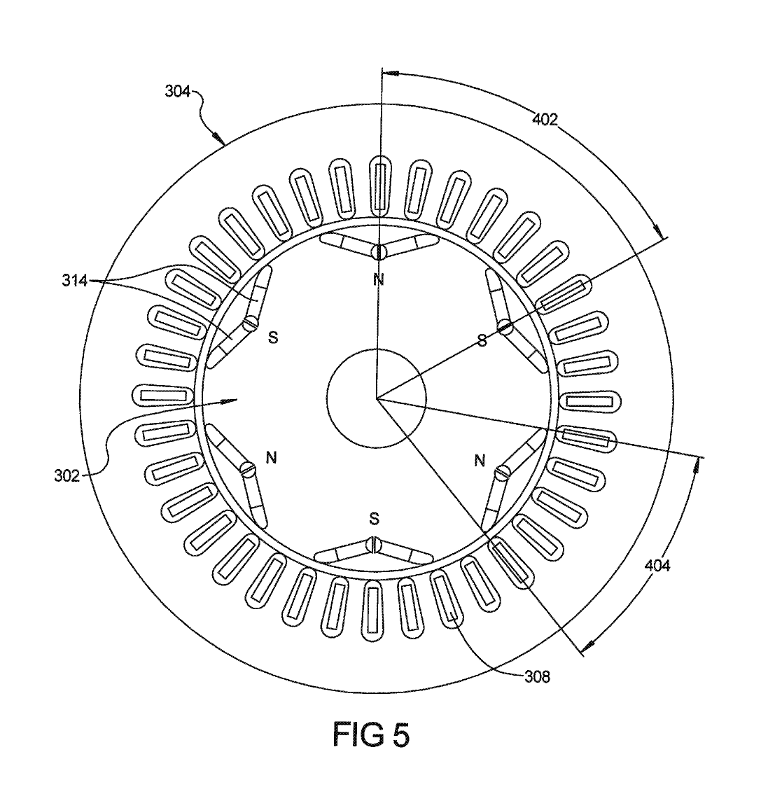

Each North and South pole in a rotor of IPM electric machine has a pole pitch and a pole arc. With reference to FIG. 5, each North and South pole of rotor 302 of IPM electric machine 300 has a pole-pitch 402 and a pole-arc 404. Each North and South pole of rotor 302 has a pole-pitch to pole-arc ratio optimized for minimum cogging torque, maximum torque and optimized core loss, which ratio is defined by:

$${α}_{p} = 1 - [ \frac{\frac{{N}_{c}}{P} - k}{\frac{{N}_{c}}{P}} ] [ \frac{n}{{( \frac{{N}_{c}}{P} )}^{2}} ] CPSR$$

### Where:

Nc=Least Common Multiple (Number of Stator Slots, Number of Poles)
P=Number of Poles
K=1, 2, 3, . . . .

$$Constant Power Speed Ratio CPSR = \frac{Maximum Speed}{Base Speed}$$

n=1 for CPSR=5 and n=0 for CPSR=2.
For CPSR values between 2 and 5, the n values are linearly interpolated between 1 and 0
n=0 for CPSR≦2 and n=1 for CPSR≧5
   The above equation is solved with different values of K's (up to a maximum of 3) to get the optimum pole-pitch to pole-arc ratio.

In the embodiment of FIG. 3, rotor 302 has eight magnet poles and thus has a pole pitch of 45 degrees. In the embodiment of FIG. 3, rotor 302 illustratively also has a pole arc of 40 degrees.

As is known, IPM electric machines typically have a plurality of rows of magnets with each row skewed with respect to the other rows. Skewing reduces the effect of slot harmonics that cause a non-uniform distribution of flux density and therefor the induced waveform. In accordance with an aspect of the present disclosure, IPM electric machine 300 has a skew angle defined by:

$$skew\_angle = \frac{360}{( {N}_{skew} + 1 ) * M} \pm δ$$

where Skew_angle is in mechanical degrees, N_{skew}=Number of skew steps, M=Least Common Multiple (Number of Stator Slots, Number of Rotor Poles), δ=variance factor (varies up to 20% due to mechanical tolerances and others)

In accordance with an aspect of the present disclosure, IPM electric machine 300 having the above discussed ratio of Stator OD to Rotor OD, an electrical angle of 135 degrees+/−one degree, between the legs of the magnet pairs and the above discussed pole-pitch to pole-arc ratio has an increased efficiency over prior art IPM electric machines allowing less magnet material to be used for a given size and power of IPM electric machine.

In an example, IPM electric machine 300 is a traction motor and has a stator with an OD of 235 mm and a stack length of 93 mm, a rotor having an OD of 140 mm, 235 Nm peak torque, 65 kW peak power and over 96% efficiency around 8000 RPM. It also illustratively has a rotor skew of 4 steps (four rows of magnets) and a skew angle of 7 degrees. In this example, the rotor magnets are neodymium iron boron magnets with the total mass of the magnets being approximately 0.75 kg, and in any event no more than 0.85 kg.

In another example, IPM electric machine 300 is a traction motor/generator and has a stator with an OD of 210 mm and a stack length of 60 mm, a rotor having an OD of 120 mm, 90 Nm peak torque, 40 kW peak power and over 96% efficiency around 6000 RPM. It also illustratively has a rotor skew of 4 steps (four rows of magnets) and a skew angle of 6 degrees. In this example, the rotor magnets are neodymium iron boron magnets with the total mass of the magnets being approximately 0.5, and in any event no more than 0.6 kg.

In each of the two foregoing examples, there is a reduction in total magnet mass required of at least 25% compared to typical prior art IPM electric machines used as traction motors or traction motor/generators in electric vehicles or hybrid electric vehicles, as applicable.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An internal permanent magnet synchronous electric machine, comprising:
a rotor having a body of ferromagnetic material with a plurality of permanent magnets disposed wholly within the body and arranged in the body of the rotor as alternate North and South poles, each North and South pole formed by a pair of the permanent magnets arranged in a V with each magnet being a leg of the V with an apex of the V radially inwardly of ends of legs of the V so that each V opens outwardly, each V having an electrical angle defined by an angle between the legs of the V that is an obtuse angle of 135 degrees±one degree;
a stator having a body of ferromagnetic material with a plurality of slots therein with conductive windings disposed in the slots;
the rotor having an outside diameter (Rotor OD) defined in terms of an outside diameter of the stator (Stator OD) as Rotor OD=Stator OD/(1.7±0.5%; and
each North and South pole of the rotor has a pole-pitch to pole-arc ratio defined by:
$${α}_{p} = 1 - [ \frac{\frac{{N}_{c}}{P} - k}{\frac{{N}_{c}}{P}} ] [ \frac{n}{{( \frac{{N}_{c}}{P} )}^{2}} ] CPSR$$
where:
Nc=Least Common Multiple (Number of Stator Slots, Number of Poles)
P=Number of Poles
K=1, 2, 3, . . . .
$$Constant Power Speed Ratio CPSR = \frac{Maximum Speed}{Base Speed}$$
n=1 for CPSR=5 and n=0 for CPSR=2.
For CPSR values between 2 and 5, the n values are linearly interpolated between 1 and 0
n=0 for CPSR≦2 and n=1 for CPSR≧5

2. The electric machine of claim 1 wherein the electric machine is a traction motor and the stator has an OD of 235 mm, a stack length of 93 mm, the rotor has an OD of 140 mm and the electric machine has a peak torque of at least 235 Nm, a peak power of at least 65 Kw, and an efficiency of greater than ninety-six percent around 8000 RPM.

3. The electric machine of claim 2 wherein the magnets are neodymium iron boron magnets and a total mass of the magnets is no more than 0.85 kg.

4. The electric machine of claim 3 wherein the total mass of the magnets is no more than approximately 0.75 kg.

5. The electric machine of claim 1 wherein the electric machine is a traction motor/generator and the stator has an OD of 210 mm, a stack length of 60 mm, the rotor has an OD of 120 mm and the electric machine has a peak torque of at least 90 Nm, a peak power of at least 40 Kw, and an efficiency of greater than ninety-six percent around 6000 RPM.

6. The electric machine of claim 5 wherein the magnets are neodymium iron boron magnets and a total mass of the magnets is no more than 0.6 kg.

7. The electric machine of claim 6 wherein the total mass of the magnets is approximately 0.5 kg.
